(19) United States
(12) Patent Application Publication
(10) Pub. No.: US 2009/0059056 A1
(43) Pub. Date: Mar. 5, 2009

(54) VIDEO CAMERA

(75) Inventors: Daisuke MIZUGUCHI, Osaka (JP); Kazuhiro TSUJINO, Osaka (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: SANYO ELECTRIC CO., LTD., Osaka (JP)

(21) Appl. No.: 12/197,644

(22) Filed: Aug. 25, 2008

(30) Foreign Application Priority Data
Aug. 28, 2007 (JP) 2007-220533
Aug. 28, 2007 (JP) 2007-220609

(51) Int. Cl. H04N 5/225; H04N 5/00

(52) U.S. Cl. 348/340; 386/117; 348/E05.024

(57) ABSTRACT

A video camera includes an image sensor. The image sensor has an imaging surface irradiated with an optical image of an object scene through a focus lens and repeatedly generates an object scene image. A position of the focus lens is repeatedly changed among three points by a driver, in parallel with a generating process of the object scene image by the image sensor. A high-frequency AF evaluation value of the object scene image generated by the image sensor is repeatedly detected by a high-frequency AF evaluation circuit and a CPU, in parallel with a changing process of the position of the focus lens. The CPU references the detected high-frequency AF evaluation value to determine a focal characteristic, and based on a determination result, adjusts the position of the focus lens to a focal position.

### CROSS REFERENCE OF RELATED APPLICATION

The disclosure of Japanese Patent Application Nos. 2007-220533 and 2007-220609 which were filed on Aug. 28, 2007 is incorporated herein by reference.

### BACKGROUND OF THE INVENTION

1. Field of the Invention

The present invention relates to a video camera. More specifically, the present invention relates to a video camera for adjusting a distance from an optical lens to an imaging surface by a called continuous AF process.

2. Description of the Related Art

According to one example of this type of video camera, whether or not a focus lens is focused/defocused is determined by fetching an AF evaluation value while the focus lens is being wobbled. When it is determined that the focus lens is in a focused state, the wobbling of the focus lens is canceled, and a restart monitoring process routine is executed. When it is determined that the focus lens is in a defocused state, a hill-climbing operation in a direction determined based on a wobbling operation is executed.

However, it is the AF evaluations at two points that are detected by the wobbling operation. Thus, it is difficult to determine a focusing characteristic of the focus lens. As a result, the restart monitoring routine or the hill-climbing operation is erroneously executed, and thus, it is probable that the focus adjusting operation may become unstable. Further, when shaking of the imaging surface is generated in a middle of the wobbling operation, a reliability in the AF evaluation value decreases. As a result, focusing/defocusing of the focus lens is erroneously determined, and thus, it is probable that the focus adjusting operation may become unstable.

### SUMMARY OF THE INVENTION

A video camera according to the present invention comprises: an imager, having an imaging surface irradiated with an optical image of an object scene through an optical lens, for repeatedly generating an object scene image; a changer for repeatedly changing a distance from the optical lens to the imaging surface among N (N: an integer of 3 or more) of values in parallel with a generating process of the object scene image by the imager; a detector for repay detecting a predetermined frequency component of the object scene image generated by the imager in parallel with a changing process of the changer, a determiner for determining a focal characteristic by referencing the predetermined frequency component detected by the detector, and an adjustor for adjusting the distance from the optical lens to the imaging surface to a distance corresponding to a focal point, based on a determination result of the determiner.

Preferably, the changer includes a switcher for alternately switching a changing direction of the distance between a diminishing direction and an increasing direction, and a modifier for periodically modifying a change amount of the distance.

Preferably, the determiner includes: a first component-amount determiner for determining whether or not an amount of a predetermined frequency component detected corresponding to a value deviated to a central value exceeds an amount of a predetermined frequency component detected corresponding to a value deviated to a maximum value; and a second component-amount determiner for determining whether or not the amount of the predetermined frequency component detected corresponding to the value deviated to the central value exceeds an amount of a predetermined frequency component detected corresponding to a value deviated to a minimum value.

Further preferably, a first measurer for measuring the number of times that both a determination result of the first component-amount determiner and a determination result of the second component-amount determiner show a negative result, and a decider for deciding a distance adjusting direction by referencing a specific luminance parameter when a number-of-times parameter based on a measuring result of the first measurer satisfies a first predetermined condition are further provided, in which the adjustor changes the distance from the optical lens to the imaging surface to the distance adjusting direction decided by the decider.

More preferably, a number-of-pixels detector for detecting the number of pixels having a luminance equivalent to a light source from the object scene image generated by the imager is further provided, in which the specific luminance parameter is equivalent to the number of pixels detected by the number-of-pixels detector.

Preferably, the decider includes a number-of-pixels determiner for determining whether or not the number of pixels detected by the number-of-pixels detector reaches a threshold value; a first direction decider for deciding, as the distance adjusting direction, a direction in which the distance from the optical lens to the imaging surface diminishes when the determination result of the number-of-pixels determiner is affirmative; and a second direction decider for deciding, as the distance adjusting direction, a direction in which the distance from the optical lens to the imaging surface increases when the determination result of the number-of-pixels determiner is negative.

Preferably, a second measurer for measuring the number of times that both a determination result of the first component-amount determiner and a determination result of the second component-amount determiner are affirmative; and a stopper for stopping the changer and the adjuster when a number-of-times parameter based on a measuring result of the second measurer satisfies a second predetermined condition are further provided.

In a certain aspect, a change amount determiner for repeatedly determining whether or not a change amount of the predetermined frequency component detected by the detector exceeds a threshold value in association with a stopping process of the stopper, and a resumer for resuming the changing process of the changer when a determination result of the change amount determiner is updated from a negative result to an affirmative result are further provided.

Preferably, a holder for holding the predetermined frequency component detected by the detector for each value designated by the changer, and an excluder for excluding the predetermined frequency component detected by the detector from a target to be noticed of the holder when the imaging surface is in a shaking state are further provided, in which the determiner executes a determining process by referencing the predetermined frequency component held by the holder.

An imaging control program product according to the present invention is an imaging control program product executed by a processor of a video camera comprising an imager, having an imaging surface irradiated with an optical image of an object scene through an optical lens, for repeatedly generating an object scene image, the imaging control program product, and comprises: a changing step of repeatedly changing a distance from the optical lens to the imaging surface among N (N: an integer of 3 or more) of values in parallel with a generating process of the object scene image by the imager, a detecting step of repeatedly detecting a predetermined frequency component of the object scene image generated by the imager in parallel with a changing process of the changing step; a determining step of determining a focal characteristic by referencing the predetermined frequency component detected by the detecting step; and an adjusting step of adjusting the distance from the optical lens to the imaging surface to a distance corresponding to a focal point based on a determination result of the determining step.

An imaging control method according to the present invention is an imaging control method executed by a video camera comprising an imager, having an imaging surface irradiated with an optical image of an object scene through an optical lens, for repeatedly generating an object scene image, the image control method comprises: a changing step of repeatedly changing a distance from the optical lens to the imaging surface among N (N: an integer of 3 or more) of values in parallel with a generating process of the object scene image by the imager a detecting step of repeatedly detecting a predetermined frequency component of the object scene image generated by the imager in parallel with a changing process of the changing step; a determining step of determining a focal characteristic by referencing the predetermined frequency component detected by the detecting step; and an adjusting step of adjusting the distance from the optical lens to the imaging surface to a distance corresponding to a focal point based on a determination result of the determining step.

A video camera according to the present invention comprises: an imager, having an imaging surface irradiated with an optical image of an object scene through an optical lens, for repeatedly generating an object scene image; a changer for repeatedly changing a distance from the optical lens to the imaging surface among a plurality of values in parallel with a generating process of the object scene image by the imager, a detector for repeatedly detecting a predetermined frequency component of the object scene image generated by the imager in parallel with a changing process of the changer, a holder for holding the predetermined frequency component detected by the detector for each numerical value designated by the changer, an adjustor for adjusting a distance from the optical lens to the imaging surface to a distance corresponding to a focal point, based on the predetermined frequency component held by the holder, and an excluder for excluding the predetermined frequency component detected by the detector corresponding to shaking of the imager from a target to be held of the holder.

Preferably, the holder overwrites a predetermined frequency component detected in a past corresponding to a designated value by a predetermined frequency component newly detected corresponding to the designated value, and an excluding process of the excluder is equivalent to a process for prohibiting an overwriting process of the holder.

Preferably, a measurer for measuring the number of times that a magnitude relation of the predetermined frequency components held by the holder shows a mutually same relation; and a decider for deciding a distance adjusting direction based on a measuring result of the measurer are further provided, in which the adjustor changes the distance from the optical lens to the imaging surface to the distance adjusting direction decided by the decider.

Further preferably, the changer changes the distance among three or more values, the holder includes a first holder for holding a predetermined frequency component detected corresponding to a value deviated to a maximum value, a second holder for holding a predetermined frequency component detected corresponding to a value deviated to a center, and a third holder for holding a predetermined frequency component detected corresponding to a value deviated to a minimum value, and the measurer includes a first number-of-times measurer for measuring the number of times indicating a relation that the predetermined frequency component held by the second holder falls below each of the predetermined frequency component held by the first holder and the predetermined frequency component held by the third holder, and a second number-of-times measurer for measuring the number of times indicating a relation that the predetermined frequency component held by the second holder exceeds each of the predetermined frequency component held by the first holder and the predetermined frequency component held by the third holder.

More preferably, the decider decides a direction different corresponding to a specific luminance parameter value as the distance adjusting direction when a number-of-times parameter based on the measuring process of the first number-of-times measurer satisfies a first predetermined condition.

In a certain aspect, a number-of-pixels detector for detecting the number of pixels having a luminance equivalent to a light source from the object scene image generated by the imager is further provided, in which the specific luminance parameter corresponds to the number of pixels detected by the number-of-pixels detector.

Further preferably, a stopper for stopping the changer and the adjuster when the number-of-times parameter based on the measuring process of the second number-of-times measurer satisfies a second predetermined condition is further provided.

In a certain aspect, a change amount determiner for repeatedly determining whether or not a change amount of the predetermined frequency component detected by the detector exceeds a threshold value in association with a stopping process of the stopper, and a resumer for resuming the changing process of the changer when a determination result of the change amount determiner is updated from a negative result to an affirmative result are further provided.

Preferably, the changer includes a switcher for alternately switching a changing direction of the distance between a diminishing direction and an increasing direction, and a modifier for periodically modifying a change amount of the distance.

An imaging control program product according to the present invention is an imaging control program product executed by a processor of a video camera comprising an imager, having an imaging surface irradiated with an optical image of an object scene through an optical lens, for repeatedly generating an object scene image, the imaging control program product, and comprises: a changing step of repeatedly changing a distance from the optical lens to the imaging surface among a plurality of values in parallel with a generating process of the object scene image by the imager a detecting step of repeatedly detecting a predetermined frequency component of the object scene image generated by the imager in parallel with a changing process of the changing step; a holding step of holding the predetermined frequency component detected by the detecting step for each numerical value designated by the changing step; an adjusting step of adjusting the distance from the optical lens to the imaging surface to a distance corresponding to a focal point based on the predetermined frequency component held by the holding step; and an excluding step of excluding the predetermined frequency component detected by the detecting step corresponding to shaking of the imaging surface from a target to be held of the holding step.

An imaging control method according to the present invention is an imaging control method executed by a video camera comprising an imager, having an imaging surface irradiated with an optical image of an object scene through an optical lens, for repeatedly generating an object scene image, the image control method comprises: a changing step of repeatedly changing a distance from the optical lens to the imaging surface among a plurality of values in parallel with a generating process of the object scene image by the imager, a detecting step of repeatedly detecting a predetermined frequency component of the object scene image generated by the imager in parallel with a changing process of the changing step; a holding step of holding the predetermined frequency component detected by the detecting step for each numerical value designated by the changing step; an adjusting step of adjusting the distance from the optical lens to the imaging surface to a distance corresponding to a focal point, based on the predetermined frequency component held by the holding step; and an excluding step of excluding the predetermined frequency component detected by the detecting step corresponding to shaking of the imaging surface from a target to be held of the holding step.

The above described features and advantages of the present invention will become more apparent from the following detailed description of the present invention when taken in conjunction with the accompanying drawings.

### BRIEF DESCRIPTION OF THE DRAWINGS

FIG. 1 is a block diagram showing a configuration of one embodiment of the present invention;

FIG. 2 is an illustrative view showing one example of an object scene captured by an imaging surface;

FIG. 3 is an illustrative view showing another example of the object scene captured by the imaging surface;

FIG. 4 is an illusive view showing one example of an operation of a focus lens at a time of a direction determination;

FIG. 5 is an illustrative view showing one example of a register setting process;

FIG. 6 is a graph showing a relation between: a lens position, and each of a high-frequency AF evaluation value and a mid-frequency AF evaluation value;

FIG. 7(A) is an illustrative view showing a portion of a characteristic of the high-frequency AF evaluation value;

FIG. 7(B) is an illustrative view showing another portion of the characteristic of the high-frequency AF evaluation value;

FIG. 7(C) is an illustrative view showing still another portion of the characteristic of the high-frequency AF evaluation value;

FIG. 8 is a flowchart showing one portion of an operation of a CPU;

FIG. 9 is a flowchart showing another portion of the operation of the CPU;

FIG. 10 is a flowchart showing still another portion of the operation of the CPU;

FIG. 11 is a flowchart showing yet still another portion of the operation of the CPU;

FIG. 12 is a flowchart showing another portion of the operation of the CPU;

FIG. 13 is a flowchart showing still another portion of the operation of the CPU;

FIG. 14 is a flowchart showing yet still another portion of the operation of the CPU;

FIG. 15 is a flowchart showing another portion of the operation of the CPU;

FIG. 16 is a flowchart showing still another portion of the operation of the CPU;

FIG. 17 is a flowchart showing yet still another portion of the operation of the CPU; and

FIG. 18 is a flowchart showing another portion of the operation of the CPU.

### DETAILED DESCRIPTION OF THE PREFERRED EMBODIMENTS

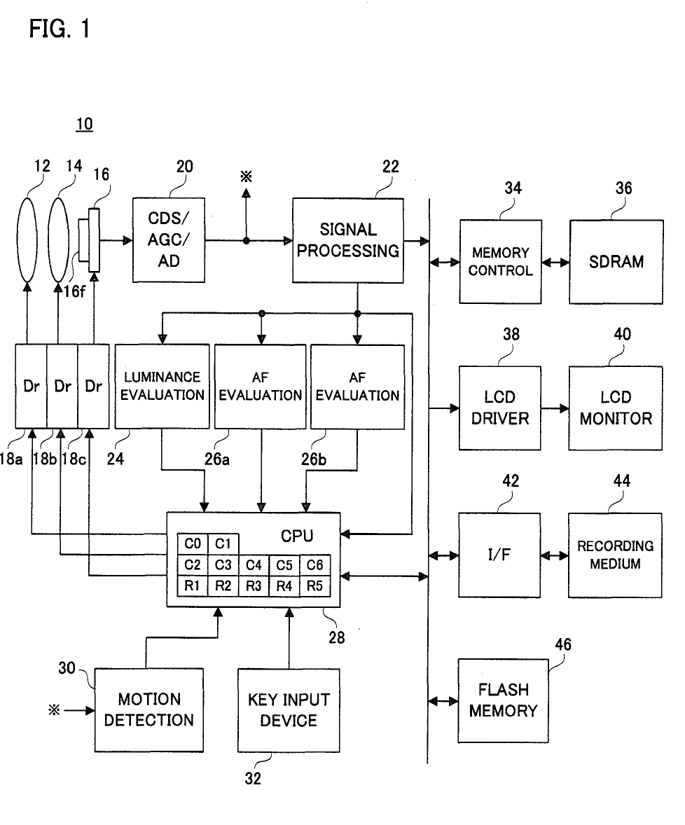

With reference to FIG. 1, a video camera 10 according to this embodiment includes a zoom lens 12 and a focus lens 14. An optical image of an object scene is irradiated onto an imaging surface 16f of an image sensor 16 through the zoom lens 12 and the focus lens 14, and photoelectrically converted. Thereby, electric charges representing an object scene image, i.e., a raw image signal is generated.

When a power source is turned on, a moving-image photographing process is started. At this time, a CPU 28 instructs a driver 18c to repeat an exposure and reading of the electric charges. The driver 18c applies a plurality of timing signals to the image sensor 16 in order to execute an exposure operation of the imaging surface 16f and a reading operation of the electric charge thus obtained. The raw image signal generated on the imaging surface 16f is applied to reading in an order according to raster scanning in response to a vertical synchronization signal Vsync generated at a rate of once each 1/60 seconds. The raw image signal is outputted from the image sensor 16 at a frame rate of 60 fps.

The raw image signal outputted from the image sensor 16 is applied to a series of processes, such as a correlative double sampling, an automatic gain adjustment, and an A/D conversion by a CDS/AGC/AD circuit 20. A signal-processing circuit 22 applies processes such as a white balance adjustment, a color separation, and a YUV conversion to the raw image data outputted from the CDS/AGC/AD circuit 20 and writes YUV-formatted image data to an SDRAM 36 through a memory control circuit 34.

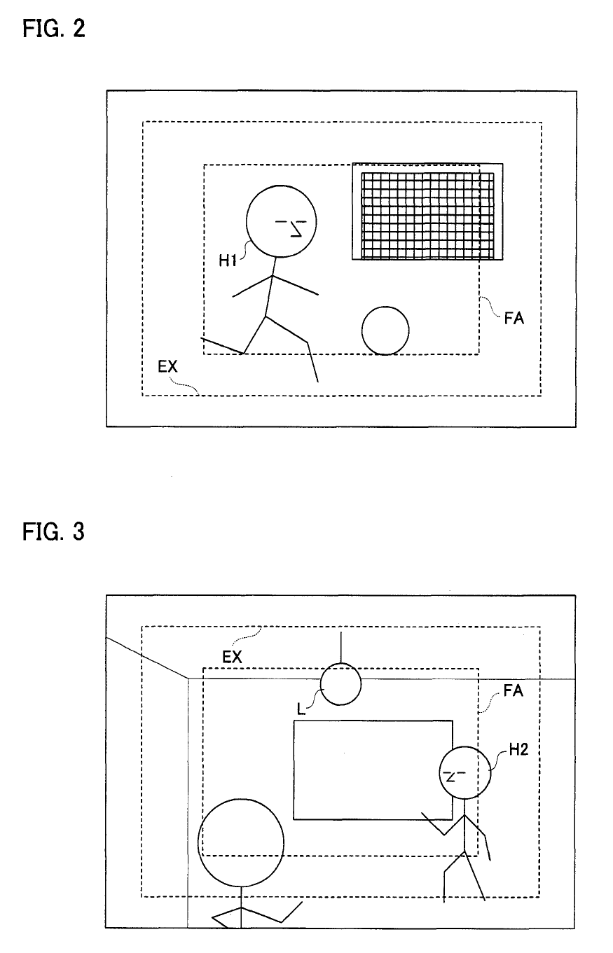

A motion detection circuit 30 fetches the raw image data outputted from the CDS/AGC/AD circuit 20 at every 1/60 seconds, and detects a motion vector indicating shaking of the imaging surface 16f based on the fetched raw image data. The detected motion vector is applied to the CPU 28. The CPU 28 moves an extraction area EX allocated on the SDRAM 36 in a manner shown in FIG. 2 to a direction in which the motion vector is canceled (compensated).

An LCD driver 38 reads out partial image data belonging to the extraction area EX through the memory control circuit 34 at every 1/60 seconds, and drives an LCD monitor 40 based on the read partial image data. As a result, a real-time moving image (through image) of the object scene is displayed on a monitor screen.

A luminance evaluation circuit 24 evaluates brightness (luminance) of the object scene at every 1/60 seconds based on Y data generated by the signal processing circuit 22. The CPU 28 adjusts an exposure amount of the image sensor 16 based on a luminance evaluation value evaluated by the luminance evaluation circuit 24. As a result, the brightness of the through image displayed on the LCD monitor 40 can moderately be adjusted.

A high-frequency AF evaluation circuit 26a fetches the Y data belonging to a focus area FA shown in FIG. 2 or FIG. 3 out of the Y data generated by the signal processing circuit 22, and integrates a high frequency component of the fetched Y data at every 1/60 seconds. Similarly, a mid-frequency AF evaluation circuit 26b fetches the Y data belonging to the above-described focus area FA out of the Y data generated by the signal processing circuit 22, and integrates a mid-frequency component of the fetched Y data at every 1/60 seconds. As a result, a high-frequency AF evaluation value is applied from the high-frequency AF evaluation circuit 26a to the CPU 28 at every 1/60 seconds, and a mid-frequency AF evaluation value is applied from the mid-frequency AF evaluation circuit 26b to the CPU 28 at every 1/60 seconds. The CPU 28 is also directly applied the Y data generated in the signal processing circuit 22.

The CPU 28 executes a continuous AF task based on the high-frequency AF evaluation value and the mid-frequency AF evaluation value applied from the high-frequency AF evaluation circuit 26a and the mid-frequency AF evaluation circuit 26b. A position of the focus lens 14 in an optical axis direction is intermittently changed by the driver 18b under control of the CPU 28. Furthermore, the CPU 28 executes a light-source determining task with reference to the Y data applied from the signal processing circuit 22. Thereby, whether or not a light source exists in the object scene is determined at every frame (= 1/60 seconds), for example. The determination result is reflected on the process of the continuous AF task.

When a zoom operation is executed by a key input device 32, the CPU 28 controls the driver 18a to move the zoom lens 12 in the optical axis direction. As a result, a magnification of the through image displayed on the LCD monitor 40 is changed.

When a recording start operation is performed by the key input device 32, the CPU 28 instructs an I/F 42 to perform a recording process. The I/F 42 reads out the partial image data belonging to the extraction area EX from the SDRAM 36 through the memory control circuit 34 at every 1/60 seconds, and creates a moving image file including the read partial image data in a recording medium 44. Such a recording process is ended in response to a recording end operation by the key input device 32.

In the light-source determining task, a pixel in which the Y data is in a state of saturation is detected out of the pixels belonging to the focus area FA. The number of such saturated pixels is counted by a high luminance counter C0. When a count value of the high luminance counter C0 is less than a threshold value TH, a light-source flag FLG is set to “0”, regarding that there is no light source in the object scene. On the other hand, when the count value of the high luminance counter C0 is equal to or more than the threshold value TH, the light source flag FLG is set to “1”, regarding that there is the light source in the object scene.

The continuous AF task is roughly configured by a direction determining process, a hill-climbing process and a monitoring process. The direction determining processing is a process for specifying a direction in which a focal point exists, i.e., a focusing direction. The hill-climbing process is a process for searching the focal point by moving the focus lens 14 in the specified focusing direction. The monitoring process is a process for monitoring whether or not the focal point is changed due to a movement of a subject itself belonging to the focus area FA or panning/tilting of the video camera 10.

Independently of these processes, the high-frequency AF evaluation value and the mid-frequency AF evaluation value are obtained from the high-frequency AF evaluation circuit 26a and the mid-frequency AF evaluation circuit 26b at each generation of the vertical synchronization signal Vsync, and a relative ratio is calculated according to Equation 1. The high-frequency AF evaluation value, the mid-frequency AF evaluation value, and the relative ratio are referenced in each of the direction determining process, the hill-climbing process, and the monitoring process, as needed.

Relative ratio=high-frequency AF evaluation value/mid-frequency AF evaluation value

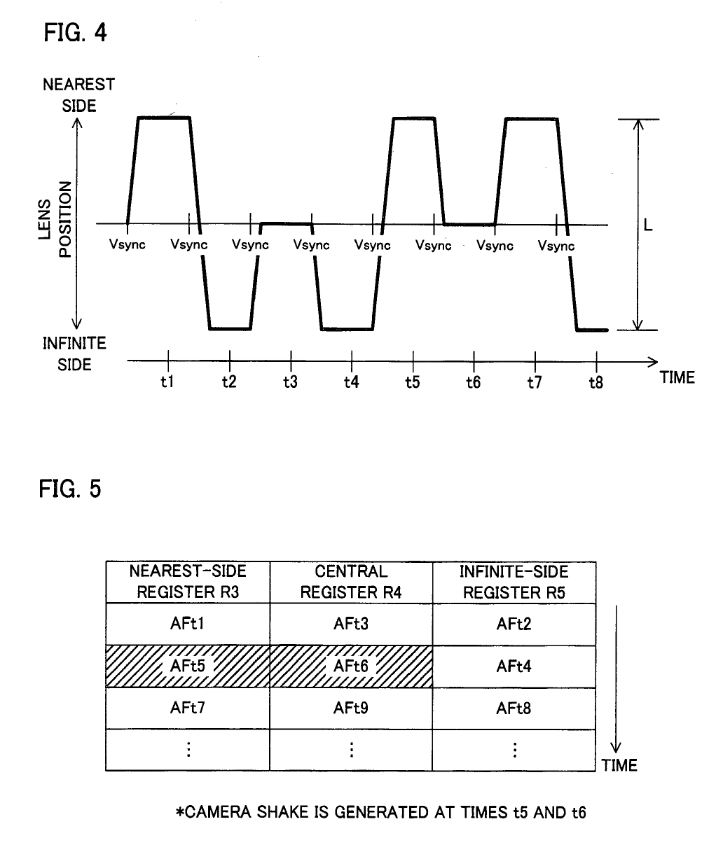

In the direction determining process, the focus lens 14 is displaced alternately on a nearest side and on an infinite side at each generation of the vertical synchronization signal Vsync. It is noted that an amount of displacement is first set to “L/2”, and thereafter, updated in a manner as in: “L”→“L/2”→“L/2”→“L”→“L/2”→“L/2” . . . at each generation of the vertical synchronization signal Vsync. That is, the amount of displacement is changed from “L/2” to “L” at a rate of once each three frames, and the focus lens 14 is displaced among three points, i.e., a nearest-side position, a central position, and an infinite-side position in a manner shown in FIG. 4.

The high-frequency AF evaluation value of the object scene image captured when the focus lens 14 is arranged at the nearest-side position is set to a nearest-side register 3; the high-frequency AF evaluation value of the object scene image captured when the focus lens 14 is arranged at the central position is set to a central register R4; and a high-frequency AF evaluation value of the object scene image captured when the focus lens 14 is arranged at the infinite-side position is set to an infinite-side register R5.

Therefore, when the high-frequency AF evaluation value of the object scene image captured at a time t*(*:1, 2,3, . . . ) is defined as “AFt*”, if the focus lens 14 is displaced in a manner shown in FIG. 4, the high-frequency AF evaluation value AFt* is set to the nearest-side register R3, the central register R4 and the infinite-side register R5 in a manner shown in FIG. 5.

It is noted that when the motion vector outputted from the motion detection circuit 30 indicates the shaking of the imaging surface 16f, the above-described register setting process is prohibited. When the shaking occurs at times t5 and t6, the setting process of a high-frequency AF evaluation value AFt5 to the nearest-side register R3 and the setting process of a high-frequency AF evaluation value AFt6 to the central register R4 are prohibited.

A magnitude relation among the high-frequency AF evaluation values set to the nearest-side register R3, the central register R4, and the infinite-side register R5 is determined at each time the focus lens 14 is displaced in a designated direction, and the count value of a vertex counter C6 is updated according to a determination result.

The vertex counter C6 is incremented when the high-frequency AF evaluation value set to the central register R4 exceeds each of the high-frequency AF evaluation value set to the nearest-side register R3 and the high-frequency AF evaluation value set to the infinite-side register R5. The vertex counter C6 is decremented when the high-frequency AF evaluation value set to the central register R4 is equal to or less than each of the high-frequency AF evaluation value set to the nearest-side register R3 and the high-frequency AF evaluation value set to the infinite-side register R5. The vertex counter C6 is further set to “0” when neither of the cases is applicable, i.e., when the high-frequency AF evaluation value shows one of an increasing tendency and a decreasing tendency toward the infinite side from the nearest side.

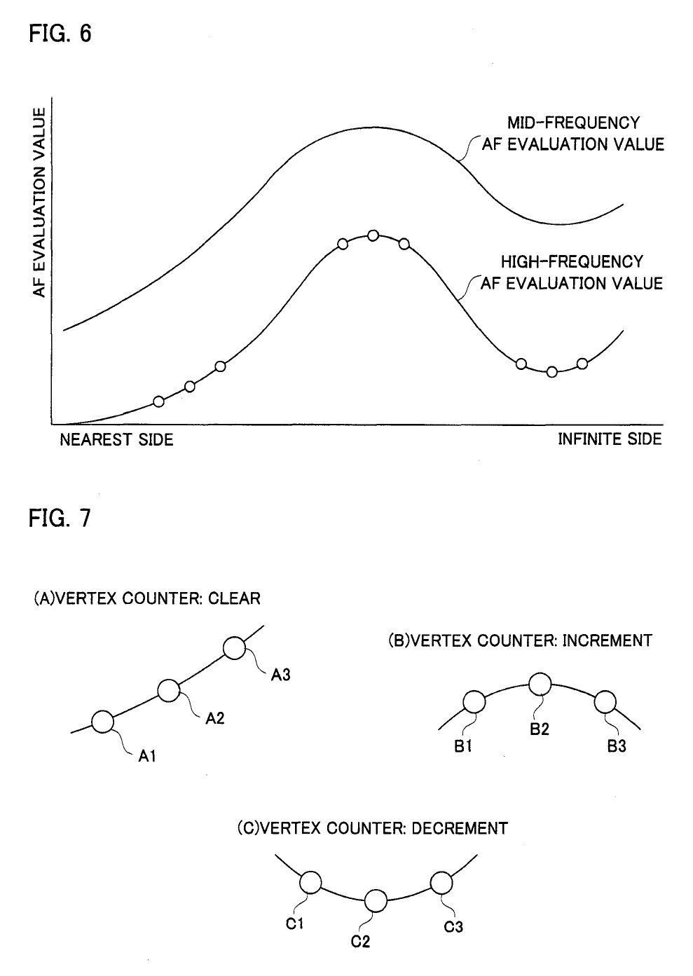

The high-frequency AF evaluation value and the mid-frequency AF evaluation value change like an arch of a mountain, for example, as shown in FIG. 6. FIG. 7(A) to FIG. 7(C) show parts of a characteristic curve of the high-frequency AF evaluation value shown in FIG. 6. The vertex counter C6 is set to “0” when the focus lens 14 is displaced among positions A1 to A3 shown in FIG. 7(A), is incremented when the focus lens 14 is displaced among positions B1 to B3 shown in FIG. 7(B), and is decremented when the focus lens 14 is displaced among the positions C1 to C3 shown in FIG. 7(C).

When the count value of the vertex counter C6 exceeds a threshold value “B”, the focus lens 14 is regarded as being in a focused state, so that the direction determining process is ended and the monitoring process is started. When the count value of the vertex counter C6 falls below the threshold value “-B”, determined as a focusing direction is a direction which is different depending upon a determination result of the light-source determining task. That is, when the light source flag FLG indicates “0”, a nearest direction is determined as a focusing direction, and when the light source flag FLG indicates “1”, an infinite direction is determined as a focusing direction. The hill-climbing process is started after the focusing direction is thus determined.

Accordingly, when an object scene not including the light source shown in FIG. 2 is photographed, the focus is set to a person H1 which is a subject nearer to the imaging surface 16f. On the other hand, when the object scene including the light source L as shown in FIG. 3 is photographed, the focus is set to a person H2 which is a subject farther away from the imaging surface 16f.

It is noted that a direction in which a distance from the focus lens 14 to the imaging surface 16f increases is the nearest direction, and a direction in which the distance from the focus lens 14 to the imaging surface 16f diminishes is the infinite direction.

In the direction determining process, in parallel with the above-described register setting process and updating process of the vertex counter C6, a magnitude relation between the high-frequency AF evaluation value obtained in a previous frame (last high-frequency AF evaluation value) and the high-frequency AF evaluation value obtained in a current frame (current high-frequency AF evaluation value) is determined. The determination process is also executed at each time the focus lens 14 is displaced in the designated direction. When the numerical value shows an increasing tendency toward the infinite direction, the direction counter C1 is incremented, and when the numerical value shows an increasing tendency toward the nearest direction, the direction counter c is decremented. As a result of the increment of the direction counter C1, the infinite direction is assumed to be the focusing direction, and as a result of the decrement of the direction counter C1, the nearest direction is assumed to be the focusing direction.

The direction counter C1 thus updated is noticed when the vertex counter C6 is equal to or more than the threshold value “-B” and equal to or less than the threshold value B. When the count value of the direction counter C1 exceeds a threshold value A, the infinite direction is determined as the focusing direction. On the other hand, when the count value of the direction counter C1 falls below the threshold value “-A”, the nearest direction is determined as the focusing direction.

An execution counter C2 is incremented at each time the focus lens 14 is displaced in the direction determining process. When a count value of the execution counter C2 exceeds a threshold value M or N before the count value of the vertex counter C6 or the count value of the direction counter C1 matches the above-described conditions, the focusing direction is determined by a direction predicting process. In the direction predicting process, when a current position of the focus lens 14 is near an infinite end, the nearest direction is determined as the focusing direction, and when the current position of the focus lens 14 is near a nearest end, the infinite direction is determined as the focusing direction.

Between the above-described threshold values M and N, a relation of N>M is established. At a time of a generation of the camera shake, the threshold value M is compared with the count value of the execution counter C2, and at a time of a non-generation of the camera shake, the threshold value N is compared with the count value of the execution counter C2. The high-frequency AF evaluation value at a time of the generation of the camera shake becomes lower than the high-frequency AF evaluation value at a time of the non-generation of the camera shake due to degradation in a high frequency components of the object scene image. Thus, the relative ratio acquired at a time of the generation of the camera shake becomes lower than that acquired at a time of the non-generation of the camera shake. Therefore, more specifically, when the relative ratio exceeds a threshold value α, the threshold value N is noticed, and when the relative ratio is equal to or less than the threshold value α, the threshold value M is noticed.

In the hill-climbing process, the focus lens 14 is moved toward the determined focusing direction, and a maximum high-frequency AF evaluation value out of the high-frequency AF evaluation values detected by the high-frequency AF evaluation circuit 26a is set to a maximum value register R. When the high-frequency AF evaluation value detected thereafter falls below the setting value of the maximum value register R1 at continuous three times in a state that the setting value of the maximum value register R1 exceeds the threshold value X, it is regarded that the focus lens 14 has passed the focal point The moving direction of the focus lens 14 is reversed, and thus, the focus lens 14 is arranged at the focal point.

When the high-frequency AF evaluation value falls below the setting value of the maximum value register R1 at continuous three times in a state that the setting value of the maximum value register R1 is equal to or less than the threshold value X and the relative ratio exceeds a threshold value β, it is regarded that the focusing direction is opposite to the moving direction at this current point The hill-climbing process is suspended once, and resumed after the moving direction is reversed.

When the high-frequency AF evaluation value falls below the setting value of the maximum value register R1 at continuous three times in a state that the setting value of the maximum value register R1 is equal to or less than the threshold value X, and the relative ratio is equal to or less than the threshold value β, the direction determining process is restarted by regarding that the focusing direction is unknown.

In the monitoring process, it is determined whether or not an amount of change in the current high-frequency AF evaluation value from the setting value of the maximum value register R1 exceeds K %. When a determination result is affirmative over a plurality of frames, by regarding Mat the focal point FP is changed due to the movement of the subject itself belonging to the focus area FA or painting/tinting of the video camera 10, the direction determining process is restarted.

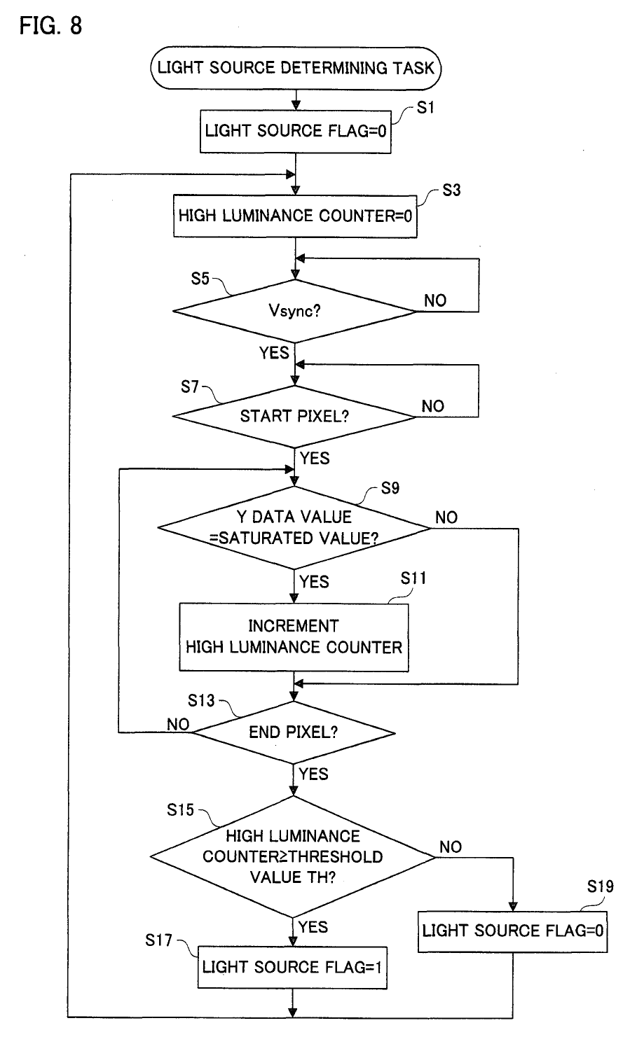

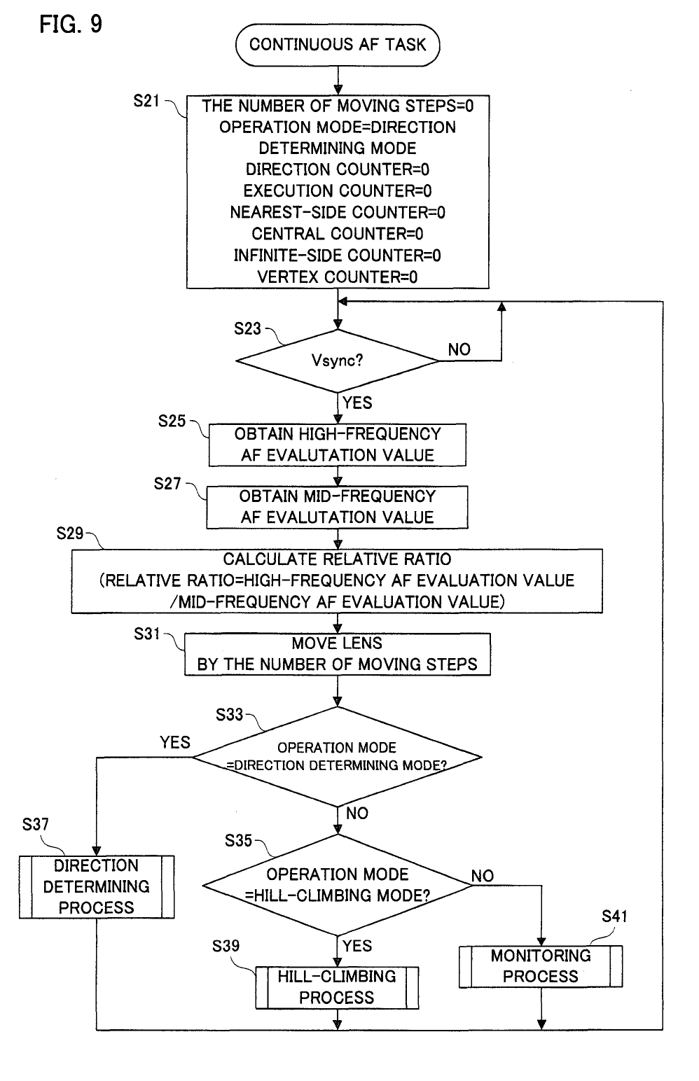

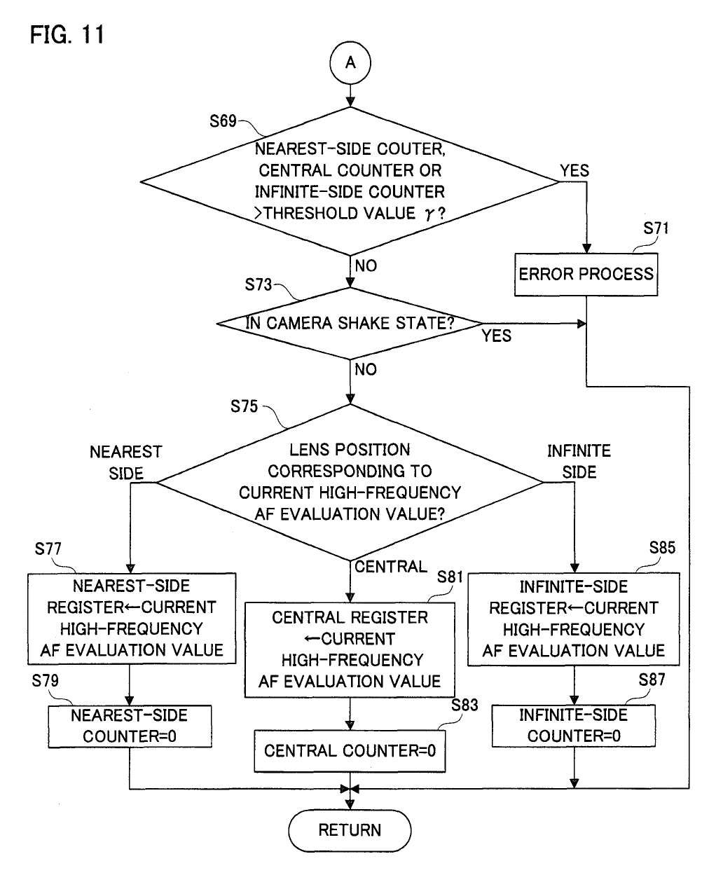

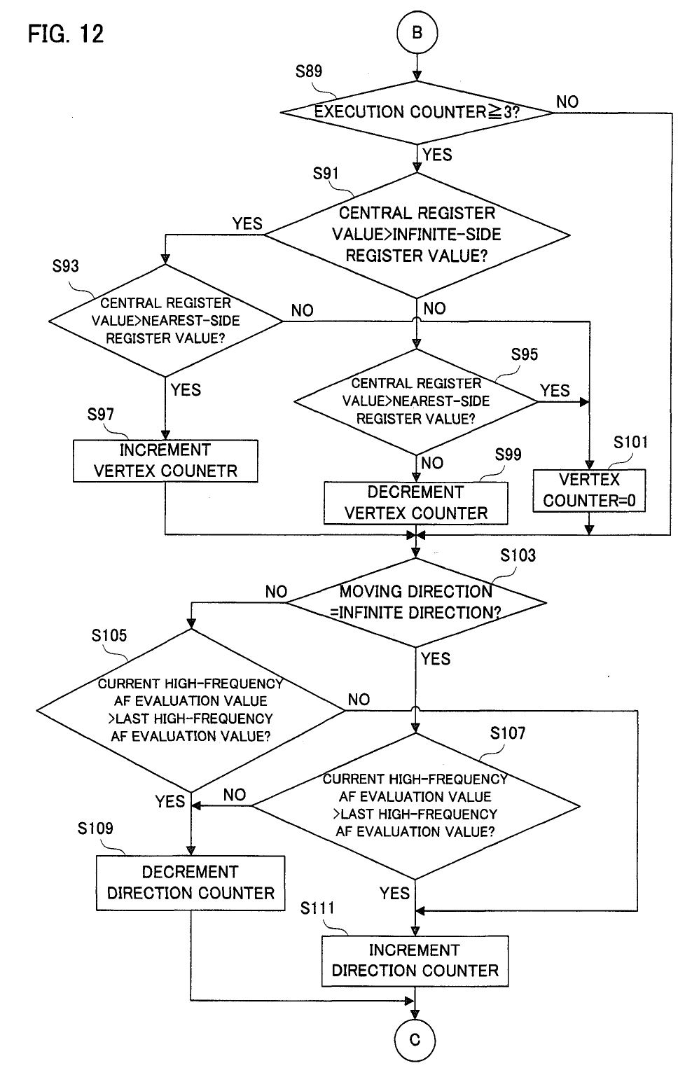

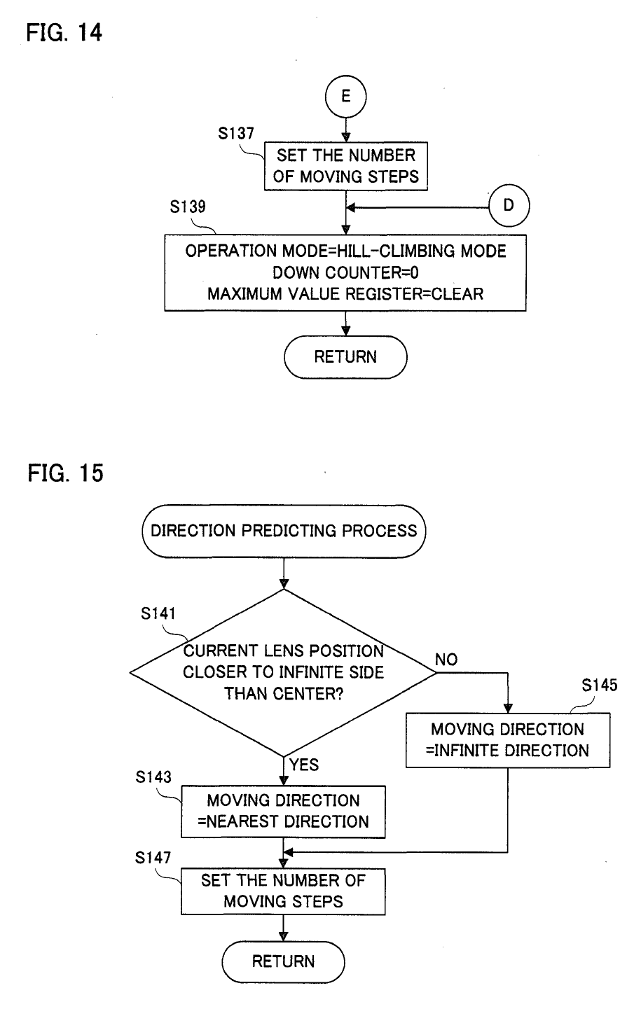

The CPU 28 executes in parallel a plurality of tasks including the light-source determining task shown in FIG. 8 and the continuous AF process task shown in FIG. 9 to FIG. 18. It is noted that control programs corresponding to these tasks are stored in a flash memory 46.

Referring to FIG. 8, the light source flag FLG is set to “0” in a step S1, and the high luminance counter C0 is set to “0” in a step S3. In a step S5, it is determined whether or not the vertical synchroriization signal Vsync is generated (whether or not 1V elapses from the immediately preceding process in the step S3), and in a step S7, it is determined whether or not a current pixel is a start pixel of the focus area FA. When YES is determined in both of the steps S5 and S7, it is determined whether or not the Y data value of the current pixel is equal to a saturated value. When NO is determined in this step, the process directly proceeds to a step S13. On the other hand, when YES is determined, by regarding that the current pixel has a luminance equivalent to the light source, the high luminance counter C0 is incremented in a step S11, and then, the process proceeds to the step S13.

In the step S13, it is determined whether or not the current pixel is an end pixel of the focus area FA, and when NO is determined, the process returns to the step S9 while when YES is determined, the process proceeds to a step S15. In the step S15, it is determined whether or not the count value of the high luminance counter C0 reaches the threshold value TH. When YES is determined in this step, by regarding that the object scene includes the light source, the light source flag FLG is set to “1” in a step S17. On the other hand, when NO is determined, by regarding that the object scene does not include the light source, “0” is set to the light source flag FLG in a step S19. Upon completion of the process in one of the steps S17 and S19, the process returns to the step S3.

Referring to FIG. 9, an initialization process is executed in a step S21. More specifically, the number of moving steps is set to “0”; an operation mode is set to a direction determining mode; and a count value of each of the direction counter C1, the execution counter C2, a nearest-side counter C3, a central counter C4, an infinite-side counter C5, and a vertex counter C6 is set to “0”. It is noted that the number of moving steps indicates the number of steps in which a stepping motor (not shown) arranged in the driver 18b is rotated in a single lens moving process.

When the vertical synchronization signal Vsync is generated, YES is determined in a step S23, the high-frequency AF evaluation value is obtained from the high-frequency AF evaluation circuit 26a in a step S25, and the mid-frequency AF evaluation value is obtained from the mid-frequency AF evaluation circuit 26b in a step S27. In a step S29, the relative ratio is calculated according to the above-described equation 1. In a step S31, the focus lens 14 is moved in a setting direction by the number of moving steps set. At a time when a first process is executed, the number of moving steps is “0”, and the moving direction is not yet determined. Thereby, the focus lens 14 remains stopped at a present position.

In a step S33, it is determined whether or not the operation mode at this point is the direction determining mode, and in a step S35, it is determined whether or not the operation mode is the hill-climbing mode. When YES is determined in the step S33, the direction determining process is executed in a step S37. When YES is determined in the step S35, the hill-climbing process is executed in a step S39, and when NO is determined in the step S35, the monitoring process is executed in a step S41. Upon completion of the process in one of the steps S37, S39 and S41, the process returns to the step S23.

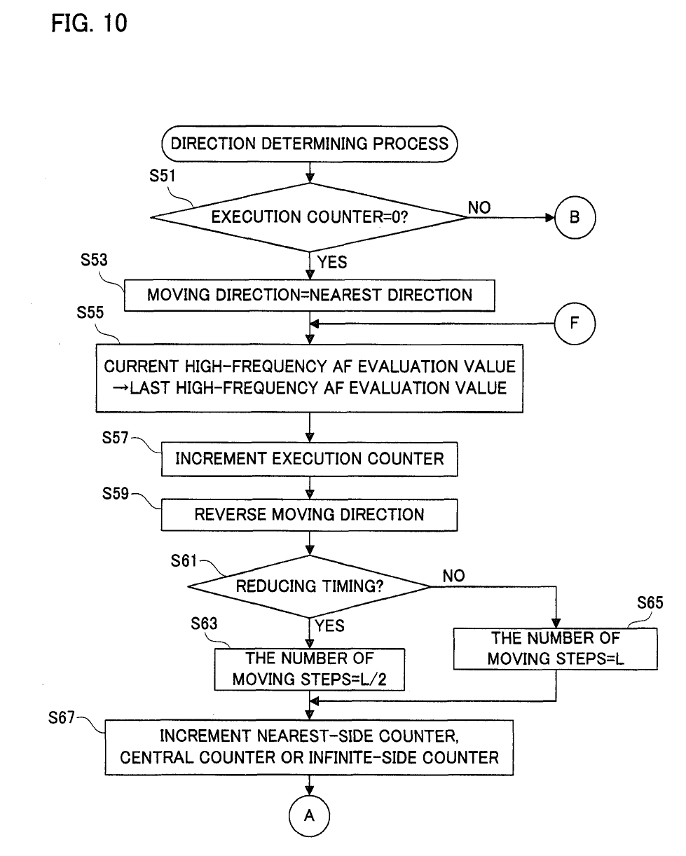

The direction determining process in the step S37 shown in FIG. 9 is executed according to a subroutine shown in FIG. 10 to FIG. 15. At first, it is determined whether or not the execution counter C2 is “0” in a step S51. When YES is determined in this step, the moving direction of the focus lens 14 is set to the nearest direction in a step S53. In a step S55, the current high-frequency AF evaluation value is held as a last high-frequency AF evaluation value. In a succeeding step S57, a setting of the moving direction of the focus lens 14 is reversed. That is, when the moving direction at this point is the nearest direction, the infinite direction is set as the moving direction, and when the moving direction at this point is the infinite direction, the nearest direction is set as the moving direction.

In a step S61, it is determined whether or not a current timing is a timing at which a lens movement amount is reduced. When YES is determined, the number of moving steps is set to the number of steps equivalent to “L2” in a step S63 while when NO is determined, the number of moving steps is set to the number of steps equivalent to “L” in a step S65. The movement amount of the focus lens 14 is first set to “12”, and thereafter, updated in a manner as in “L”→“L2”→“L2”→“L”→“L2”→“L2” . . . at each generation of the vertical synchronization signal Vsync. That is, the amount of movement is changed from “L2” to “L” at a rate of once each three frames, and the focus lens 14 is displaced among the three points, i.e., a nearest-side position, a central position, and an infinite-side position, in a manner shown in FIG. 4.

Upon completion of the process in one of the steps S63 and S65, one of the nearest-side counter C3, the central counter C4, and the infinite-side counter C5 is incremented in a step S67. When the displaced lens position is the nearest-side position, the nearest-side counter C3 is incremented; when the displaced lens position is the central position, the central counter C4 is incremented, and when the displaced lens position is the infinite-side position, the infinite-side counter C5 is incremented.

In a step S69, it is determined whether or not the count value of one of the nearest-side counter C3, the central counter C4, and the infinite-side counter C5 exceeds a threshold value y. In a step S73, it is determined based on the motion vector outputted from the motion detection circuit 30 whether or not the imaging surface 16f is in a shaking state when the object scene image as a detection source of the current high-frequency AF evaluation value is captured.

The process in the step S69 is a process for determining whether or not the setting value of one of the nearest-side register R3, the central register R4, the infinite-side register R5 lacks reliability. When YES is determined in this step, an err process is performed in a step S71, and then, the process is restored to a routine at a hierarchical upper level. Furthermore, when YES is determined in the step S73, by regarding that the current high-frequency AF evaluation value cannot serve as a reference as to the direction determination, the process is directly restored to a routine at a hierarchical upper level. When NO is determined in the step S69 and when NO is determined in the step S73, the position of the focus lens 14 when the object scene image as a detection source of the current high-frequency AF evaluation value is captured is determined in a step S75.

When a determination result indicates the nearest-side position, the current high-frequency AF evaluation value is set to the nearest-side register R3 in a step S77, and the nearest-side counter C3 is set to “0” in a step S79. When the determination result indicates the nearest-side position, the current high-frequency AF evaluation value is set to the central register R4 in a step S81, and the central counter C4 is set to “0” in a step S83. When the determination result indicates the nearest-side position, the current high-frequency AF evaluation value is set to the infinite-side register R5 in a step S85, and the infinite-side counter C5 is set to “0” in a step S87. Upon completion of the process in one of the step S79, S83, and S87, the process is restored to a routine at a hierarchical upper level.

When NO is determined in the step S51 shown in FIG. 10, it is determined whether or not the count value of the execution counter C2 is equal to or more than “3” in a step S89. When NO is determined in this step, the process directly proceeds to a step S103 while when YES is determined, the process proceeds to the step S103 through processes from steps S91 to S101.

In the step S91, it is determined whether or not the setting value of the central register R4 exceeds the setting value of the infinite-side register R5, and in each of the steps S93 and S95, it is determined whether or not the setting value of the central register R4 exceeds the setting value of the nearest-side register R3. When YES is determined in each of the steps S91 and S93, by regarding that the high-frequency AF evaluation value changes in a manner shown in FIG. 7(B), the vertex counter C6 is incremented in the step S101. When NO is determined in each of the steps S91 and S95, by regarding that the high-frequency AF evaluation value changes in a manner shown in FIG. 7(C), the vertex counter C6 is decremented in the step S99.

When NO is determined in the step S91 and YES is determined in the step S95, by regarding that the high-frequency AF evaluation value changes in a manner shown in FIG. 7(A), the vertex counter C6 is set to “0” in the step S101. When YES is determined in the step S91 and when NO is determined in the step S93, by regarding that the high-frequency AF evaluation value changes in a manner opposite to that in FIG. 7(A), the vertex counter C6 is set to “0” in the step S101.

In the step S103, it is determined whether or not the moving direction at this point is the infinite direction. When NO is determined, the process proceeds to a step S105 while when YES is determined, the process proceeds to a step S107. In each of the steps S105 and S107, it is determined whether or not the current high-frequency AF evaluation value exceeds the last high-frequency AF evaluation value. It is noted that in the step S105, when a determination result is “YES”, the process proceeds to a step S109, and when the determination result is “NO”, the process proceeds to a step S111. On the other hand, in the step S107, when a determination result is “YES”, the process proceeds to the step S111, and when the determination result is “NO”, the process proceeds to the step S109.

In the step S109, the direction counter C1 is decremented, and in the step S111, the direction counter C1 is incremented. Upon completion of the process in one of the steps S109 and S111, it is determined whether or not the relative ratio calculated in the step S29 exceeds the threshold value c in a step S113. When YES is determined in this step, by regarding that the imaging surface 16f is not in a shaking state, the process proceeds to a step S115. When NO is determined, by regarding that the imaging surface 16f is in a shaking state, the process proceeds to the step S113.

In the step S115, it is determined whether or not the count value of the execution counter C2 exceeds a threshold value N (N:20, for example), and in a step S117, it is determined whether or not the count value of the execution counter C2 exceeds a threshold value M (M:10, for example). When YES is determined in one of the steps S115 and S117, the process proceeds to a step S139 through the direction predicting process in a step S119. In the step S139, the operation mode is set to the hill-climbing mode, the down counter C7 is set to “0”, and the maximum value register R1 is cleared. Upon completion of the process in the step S139, the process is restored to a routine at a hierarchical upper level.

On the other hand, when NO is determined in one of the steps S115 and S117, it is determined whether or not the count value of the vertex counter C6 exceeds a threshold value B in a step S121, and it is determined whether or not the count value of the vertex counter C6 falls below a threshold value “-B” in a step S125. Furthermore, it is determined whether or not the count value of the direction counter C1 exceeds a threshold value A in a step S129, and it is determined whether or not the count value of the direction counter C1 falls below a threshold value “-A” in a step S131. It is noted that the numerical value B is “3”, for example, and the numerical value A is “5”, for example.

When YES is determined in the step S121, the operation mode is set to a monitoring mode in a step S123, and then, the process is restored to a routine at a hierarchical upper level. When YES is determined in the step S125, it is determined whether or not the light source flag FLG is “1” in a step S127. When YES is determined in this step, the infinite direction is regarded as the focusing direction, and the moving direction is set to the infinite direction in a step S133. On the other hand, when NO is determined, the nearest direction is regarded as the focusing direction, and the moving direction is set to the nearest direction in a step S135. When YES is determined in the step S129, the process proceeds to the step S133, and when YES is determined in the step S131, the process proceeds to the step S135. When NO is determined in both of the steps S129 and S131, the process returns to the step S55. Upon completion of the process in one of the steps S133 and S135, the number of moving steps is set to a value equal to or more than “1” in a step S137, and then, the process proceeds to the step S139.

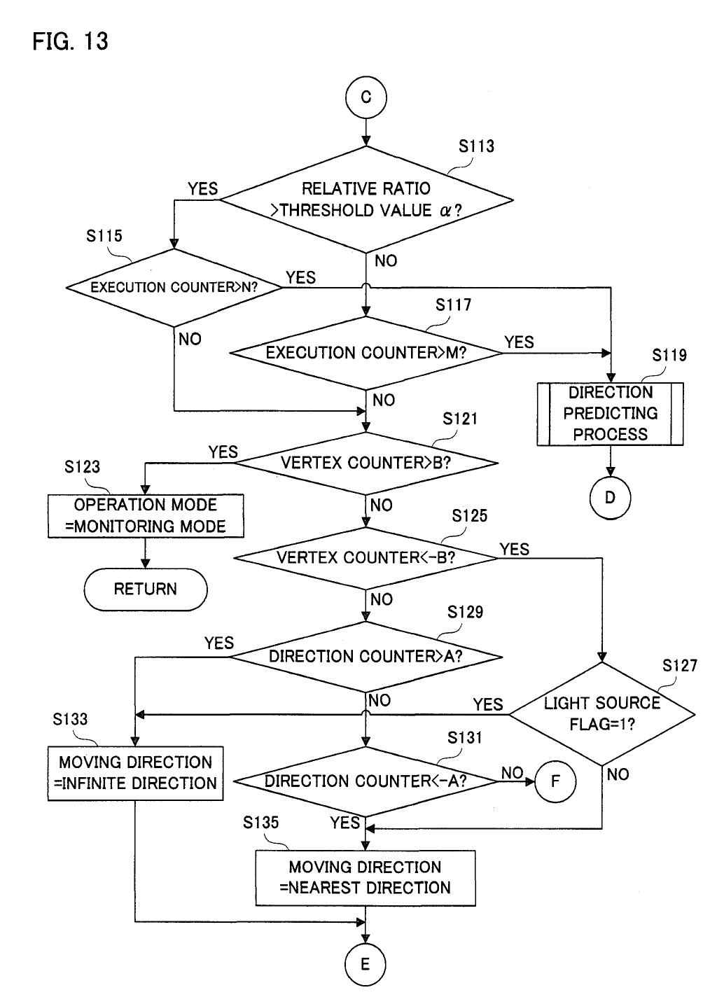

The direction predicting process in the step S119 shown in FIG. 13 is executed according to a subroutine shown in FIG. 15. At fig it is determined whether or not a current position of the focus lens 14 is nearer to the infinite side than a center of the moving range in a step S141. When YES is determined in this step, the nearest direction is regarded as the focusing direction, and the moving direction is set to the nearest direction in a step S143. On the other hand, when NO is determined, the infinite direction is regarded as the focusing direction, and the moving direction is set to the infinite direction in a step S145. In a step S147, the number of moving steps is set to a value equal to or more than “1”, and then, the process is restored to a routine at a hierarchical upper level.

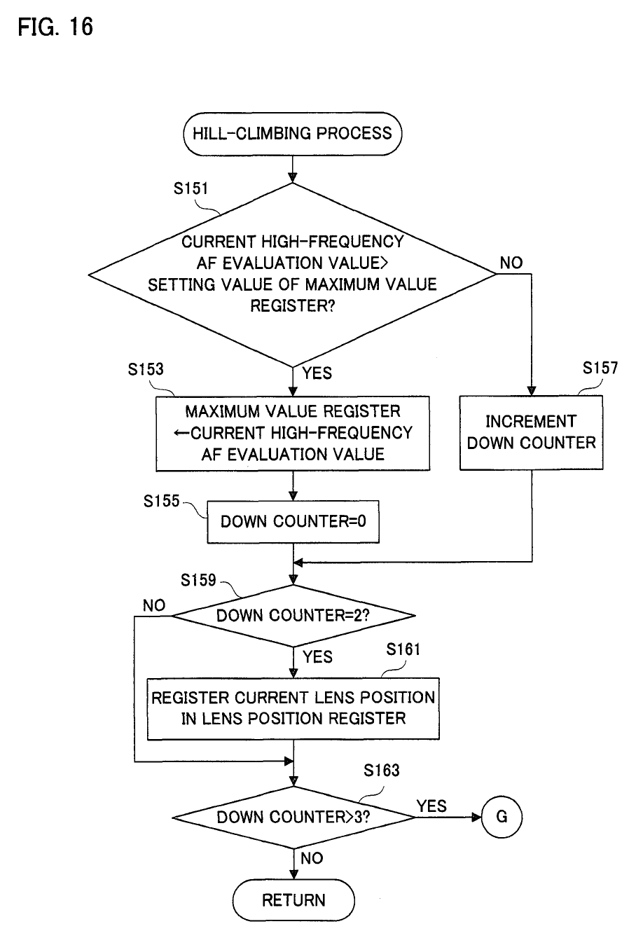

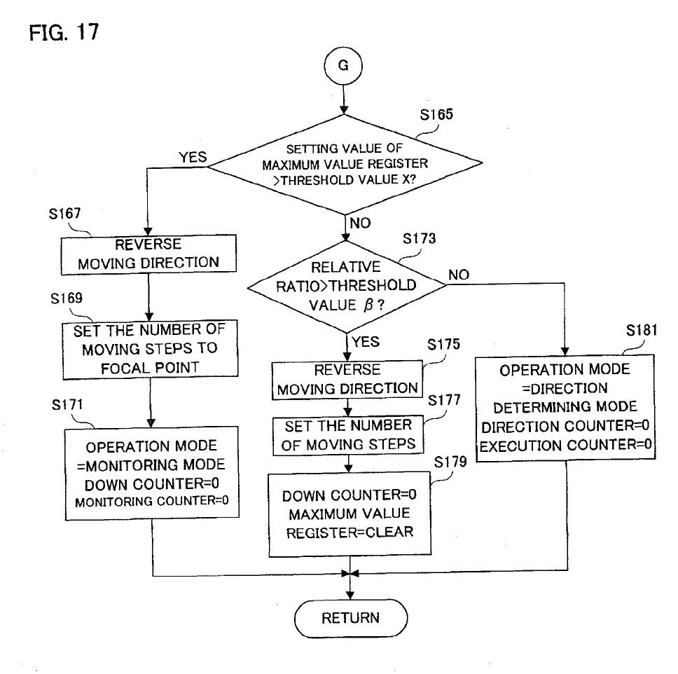

The hill-climbing process in the step S39 shown in FIG. 9 is executed according to a subroutine shown in FIG. 16 and FIG. 17. In a step S151, it is determined whether or not the current high-frequency AF evaluation value exceeds the setting value of the maximum value register R1. When YES is determined in this step, the current high-frequency AF evaluation value is set to the maximum value register R1 in a step S153, and the down counter C7 is set to “0” in a step S155. When NO is determined, the down counter C7 is incremented in a step S157. Upon completion of the process in one of the steps S155 and S157, it is determined whether or not the count value of the down counter C7 is “2” in a step S159.

When NO is determined in this step, the process directly proceeds to a step S163 while when YES is determined, the current position of the focus lens 14 is registered in the lens position register R2 in a step S161, and then, the process proceeds to the step S163. In the step S163, it is determined whether or not the count value of the down counter C7 exceeds “3”. When NO is determined, the process is returned to a routine at a hierarchical upper level while when YES is determined, it is determined whether or not the setting value of the maximum value register R1 exceeds a threshold value X in a step S165.

When YES is determined in the step S165, by regarding that the focus lens 14 passes the focal point, the moving direction is reversed in a step S167. In a step S169, a focal point FP is specified based on the lens position registered in the lens position register R2, and the number of moving steps to the specified focal point FP is set. In a step S171, the operation mode is set to the monitoring mode, and the count value of each of the down counter C7 and the monitoring counter C8 is set to “0”. Upon completion of the process in the step S171, the process is restored to a routine at a hierarchical upper level.

When NO is determined in the step S165, the process proceeds to a step S173 in order to cancel the hill-climbing process. In the step S173, it is determined whether or not the relative ratio calculated in the step S29 exceeds the threshold value P. When YES is determined here, by regarding that the moving direction of the focus lens 14 is a direction opposite toward the focal point, the moving direction is reversed in a step S175, and the number of moving steps is set to a value equal to or more than “1” in a step S177. In a step S179, the down counter C7 is set “0”, and the maximum value register R1 is cleared. Upon completion of the process in the step S179, the process is restored to a routine at a hierarchical upper level. As a result, the hill-climbing process is restarted.

When NO is determined in both of the step S165 and step S173, the process proceeds to a step S181 to set the operation mode to the direction determining mode and set each of the direction counter C1 and the execution counter C2 to “0”. Upon completion of the process in the step S181, the process is restored to a routine at a hierarchical upper level. As a result, the direction determining process is restarted.

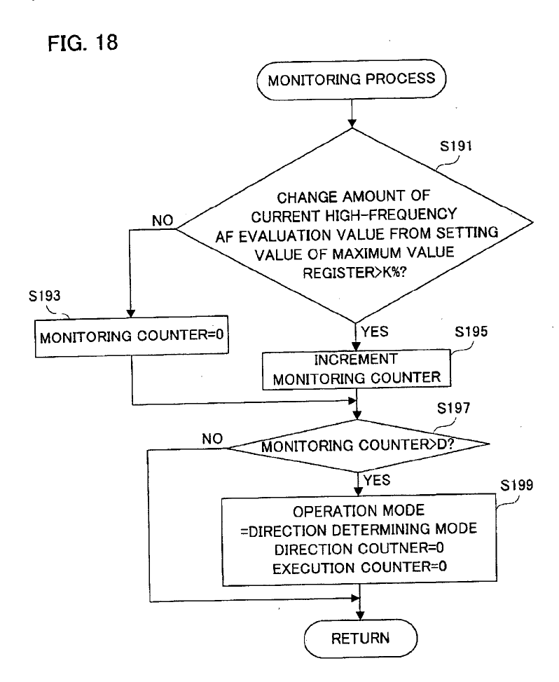

The monitoring process in the step S41 shown in FIG. 9 is executed according to a subroutine shown in FIG. 18. At first, in a step S191, it is determined whether or not the amount of change in the current high-frequency AF evaluation value from the setting value in the maximum value register R1 exceeds K %. When NO is determined in this step, the monitoring counter C8 is set to “0” in a step S193 while when YES is determined, the monitoring counter C8 is incremented in a step S195. Upon completion of the process in one of the steps S193 and S195, it is determined whether or not the count value of the monitoring counter C8 exceeds a threshold value D in a step S197. When NO is determined in this step, the process is directly restored to a routine at a hierarchical upper level. When YES is determined, the operation mode is set to the direction determining mode in a step S199, each of the direction counter C1 and the execution counter C2 is set to “0”, and then, the process is restored to a routine at a hierarchical upper level.

As is apparent from the above descriptions, the image sensor 16 has the imaging surface 16f irradiated with the optical image of the object scene through the focus lens 14, and it reply generates the object scene images. The position of the focus lens 14 is repeatedly changed among the three points by the driver 18b (S31, S59 to S65) in parallel with a generating process of the object scene image by the image sensor 16. The high-frequency AF evaluation value of the object scene image generated by the image sensor 16 is repeatedly detected by the high-frequency AF evaluation circuit 26a and the CPU 28 (S25) in parallel with the position changing process of the focus lens 14.

The CPU 28 holds the detected high-frequency AF evaluation values for each setting position of the focus lens 14 (S77, S81, S85), references the held high-frequency AF evaluation values to determine a focusing characteristic (S91 to S95), and based on the determination result, adjusts the position of the focus lens 14 to the focal point (S39). It is noted that the high-frequency AF evaluation value detected in response to the shaking of the imaging surface 16f is excluded from a target to be held (S73).

By repeatedly changing the position of the focus lens 14 among the three points, three high-frequency AF evaluation values respectively corresponding to the tree points are detected. Thereby, the precision of determination on of the focusing characteristic is improved. Furthermore, the high-frequency AF evaluation value detected in response to the shaking of the imaging surface 16f is excluded from the target to be held. Thus, a focusing adjustment is accurately executed irrespective of the shaking of the imaging surface 16f. Thereby, it is possible to stabilize the focus adjusting operation.

Additionally, when the focal point exists in both of the nearest direction and the infinite direction, the moving direction of the focus lens 14 is determined by presence or absence of the light source. That is, when the object scene includes the light source, a focal point existing the infinite direction is searched. The focus is set to a subject farther than the light source. On the other hand, when the object scene does not include the light source, the focal point existing in the nearest direction is searched. The focus is set to a subject nearer to the imaging. As described above, a direction in which the distance from the focus lens 14 to the imaging surface 16f increases is the nearest direction, and a direction in which the distance from the focus lens 14 to the imaging surface 16f diminishes is the infinite direction. This makes it possible to realize good focus control.

It is noted that in this embodiment, the focus lens 14 is moved in an optical axis direction in the focus adjustment. However, the image sensor 16 may be moved in the optical axis direction in place of the focus lens 14 or together with the focus lens 14. Furthermore, in this embodiment, the focus lens 14 is displaced among the three positions for the direction determining process, and however, the focus lens 14 may be displaced among four or more positions. It is noted that a generation cycle of the vertical synchronization signal Vsync is assumed as 1/60 seconds in this embodiment, and however, the generation cycle is not limited to this.

Although the present invention has been described and illustrated in detail, it is clearly understood that the same is by way of illustration and example only and is not to be taken by way of limitation, the spit and scope of the present invention being limited only by the terms of the appended claims.

What is claimed is:

1. A video camera, comprising:
an imager, having an imaging surface irradiated with an optical image of an object scene through an optical lens, for repeatedly generating an object scene image;
a changer for repeatedly changing a distance from said optical lens to said imaging surface among N (N: an integer of 3 or more) of values in parallel with a generating process of the object scene image by said imager
a detector for repeatedly detecting a predetermined frequency component of the object scene image generated by said imager in parallel with a changing process of said changer,
a determiner for determining a focal characteristic by referencing the predetermined frequency component detected by said detector, and
an adjustor for adjusting the distance from said optical lens to said imaging surface to a distance corresponding to a focal point, based on a determination result of said determiner.

2. A video camera according to claim 1, wherein said changer includes a switcher for alternately switching a changing direction of the distance between a diminishing direction and an increasing direction, and a modifier for periodically modifying a change amount of the distance.

3. A video camera according to claim 1, wherein said determiner includes: a first component-amount determiner for determining whether or not an amount of a predetermined frequency component detected corresponding to a value deviated to a central value exceeds an amount of a predetermined frequency component detected corresponding to a value deviated to a maximum value; and a second component-amount determiner for determining whether or not the amount of the predetermined frequency component detected corresponding to the value deviated to the central value exceeds an amount of a predetermined frequency component detected corresponding to a value deviated to a minimum value.

4. A video camera according to claim 3, further comprising:
a first measurer for measuring the number of times that both a determination result of said first component-amount determiner and a determination result of said second component-amount determiner show a negative result; and
a decider for deciding a distance adjusting direction by referencing a specific luminance parameter when a number-of-times parameter based on a measuring result of said first measurer satisfies a first predetermined condition,
wherein said adjustor changes the distance from said optical lens to said imaging surface to the distance adjusting direction decided by said decider.

5. A video camera according to claim 4, further comprising a number-of-pixels detector for detecting the number of pixels having a luminance equivalent to a light source from the object scene image generated by said imager, wherein
the specific luminance parameter is equivalent to the number of pixels detected by said number-of-pixels detector.

6. A video camera according to claim 4, wherein said decider includes: a number-of-pixels determiner for determining whether or not the number of pixels detected by said number-of-pixels detector reaches a threshold value; a first direction decider for deciding, as the distance adjusting direction, a direction in which the distance from said optical lens to said imaging surface diminishes when the determination result of said number-of-pixels determiner is affirmative; and a second direction decider for deciding, as the distance adjusting direction, a direction in which the distance from said optical lens to said imaging surface increases when the determination result of said number-of-pixels determiner is negative.

7. A video camera according to claim 3, flier comprising:
a second measurer for measuring the number of times that both a determination result of said first component-amount determiner and a determination result of said second component-amount determiner are affirmative; and
a stopper for stopping said changer and said adjuster when a number-of-times parameter based on a measuring result of said second measurer satisfies a second predetermined condition.

8. A video camera according to claim 7, further comprising:
a change amount determiner for repeatedly determining whether or not a change amount of the predetermined frequency component detected by said detector exceeds a threshold value in association with a stopping process of said stopper; and
a resumer for resuming the changing process of said changer when a determination result of said change amount determiner is updated from a negative result to an affirmative result.

9. A video camera according to claim 1, further comprising:
a holder for holding the predetermined frequency component detected by said detector for each value designated by said changer, and
an excluder for excluding the predetermined frequency component detected by said detector from a target to be noticed of said holder when said imaging surface is in a shaking state, wherein
said determiner executes a determining process by referencing the predetermined frequency component held by said holder.

10. An imaging control program product executed by a processor of a video camera comprising an imager, having an imaging surface irradiated with an optical image of an object scene through an optical lens, for repeatedly generating an object scene image, the imaging control program product, comprising:
a changing step of repeatedly changing a distance from said optical lens to said imaging surface among N (N: an integer of 3 or more) of values in parallel with a generating process of the object scene image by said imager,
a detecting step of repeatedly detecting a predetermined frequency component of the object scene image generated by said imager in parallel with a changing process of said changing step;
a determining step of determining a focal characteristic by referencing the predetermined frequency component detected by said detecting step; and
an adjusting step of adjusting the distance from said optical lens to said imaging surface to a distance corresponding to a focal point based on a determination result of said determining step.

11. An imaging control method executed by a video camera comprising an imager, having an imaging surface irradiated with an optical image of an object scene through an optical lens, for repeatedly generating an object scene image, the imaging control method, comprising:
a changing step of repay changing a distance from said optical lens to said imaging surface among N (N: an integer of 3 or more) of values in parallel with a generating process of the object scene image by said imager,
a detecting step of repeatedly detecting a predetermined frequency component of the object scene image generated by said imager in parallel with a changing process of said changing step;
a determining step of determining a focal characteristic by referencing the predetermined frequency component detected by said detecting step; and
an adjusting step of adjusting the distance from said optical lens to said imaging surface to a distance corresponding to a focal point based on a determination result of said determining step.

12. A video camera, comprising:
an imager, having an imaging surface irradiated with an optical image of an object scene through an optical lens, for ret y generating an object scene image;
a changer for repeatedly changing a distance from said optical lens to said imaging surface among a plurality of values in parallel with a generating process of the object scene image by said imager
a detector for repeatedly detecting a predetermined frequency component of the object scene image generated by said imager in parallel with a changing process of said changer;
a holder for holding the predetermined frequency component detected by said detector for each numerical value designated by said changer,
an adjustor for adjusting a distance from said optical lens to said imaging surface to a distance corresponding to a focal point, based on the predetermined frequency component held by said holder, and
an excluder for excluding the predetermined frequency component detected by said detector corresponding to shaking of said imager from a target to be held of said holder.

13. A video camera according to claim 12, wherein said holder overwrites a predetermined frequency component detected in a past corresponding to a designated value by a predetermined frequency component newly detected corresponding to the designated value, and an excluding process of said excluder is equivalent to a process for prohibiting an overwriting process of said holder.

14. A video camera according to claim 12, further comprising:
a measurer for measuring the number of times that a magnitude relation of the predetermined frequency components held by said holder shows a mutually same relation; and
a decider for deciding a distance adjusting direction based on a measuring result of said measurer,
wherein said adjustor changes the distance from said optical lens to said imaging surface to the distance adjusting direction decided by said decider.

15. A video camera according to claim 14, wherein
said changer changes the distance among three or more values,
said holder includes a first holder for holding a predetermined frequency component detected corresponding to a value deviated to a maximum value, a second holder for holding a predetermined frequency component detected corresponding to a value deviated to a center, and a third holder for holding a predetermined frequency component detected corresponding to a value deviated to a minimum value, and
said measurer includes a first number-of-times measurer for measuring the number of times indicating a relation that the predetermined frequency component held by said second holder falls below each of the predetermined frequency component held by said first holder and the predetermined frequency component held by said third holder, and a second number-of-times measurer for measuring the number of times indicating a relation that the predetermined frequency component held by said second holder exceeds each of the predetermined frequency component held by said first holder and the predetermined frequency component held by said third holder.

16. A video camera according to claim 15, wherein said decider decides a direction different corresponding to a specific luminance parameter value as said distance adjusting direction when a number-of-times parameter based on the measuring process of said first number-of-ties measurer satisfies a first predetermined condition.

17. A video camera according to claim 16, further comprising a number-of-pixels detector for detecting the number of pixels having a luminance equivalent to a light source from the object scene image generated by said imager, wherein the specific luminance parameter corresponds to the number of pixels detected by said number-of-pixels detector.

18. A video camera according to claim 15, further comprising a stopper for stopping said changer and said adjuster when the number-of-times parameter based on the measuring process of said second number-of-times measurer satisfies a second predetermined condition.

19. A video camera according to claim 18, further comprising:
a change amount determiner for repeatedly determining whether or not a change amount of the predetermined frequency component detected by said detector exceeds a threshold value in association with a stopping process of said stopper, and
a resumer for resuming the changing process of said changer when a determination result of said change amount determiner is updated from a negative result to an affirmative result.

20. A video camera according to claim 12, wherein said changer includes a switcher for alternately switching a changing direction of the distance between a diminishing direction and an increasing direction, and a modifier for periodically modifying a change amount of the distance.

21. An imaging control program product executed by a processor of a video camera comprising an imager, having an imaging surface irradiated with an optical image of an object scene through an optical lens, for repeatedly generating an object scene image, the imaging control program product, comprising:
a changing step of repeatedly changing a distance from said optical lens to said imaging surface among a plurality of values in parallel with a generating process of the object scene image by said imager
a detecting step of a y detecting a predetermined frequency component of the object scene image generated by said imager in parallel with a changing process of said changing step;
a holding step of holding the predetermined frequency component detected by said detecting step for each numerical value designated by said changing step;
an adjusting step of adjusting the distance from said optical lens to said imaging surface to a distance corresponding to a focal point, based on the predetermined frequency component held by said holding step; and
an excluding step of excluding the predetermined frequency component detected by said detecting step corresponding to shaking of said imaging surface from a target to be held of said holding step.

22. An imaging control method executed by a video camera comprising an imager, having an imaging surface irradiated with an optical image of an object scene through an optical lens, for repeatedly generating an object scene image, the imaging control method, comprising:
a changing step of repeatedly changing a distance from said optical lens to said imaging surface among a plurality of values in parallel with a generating process of the object scene image by said imager;
a detecting step of repeatedly detecting a predetermined frequency component of the object scene image generated by said imager in parallel with a changing process of said changing step;
a holding step of holding the predetermined frequency component detected by said detecting step for each numerical value designated by said changing step;
an adjusting step of adjusting the distance from said optical lens to said imaging surface to a distance corresponding to a focal point, based on the predetermined frequency component held by said holding step; and
an excluding step of excluding the predetermined frequency component detected by said detecting step corresponding to shaking of said imaging surface from a target to be held of said holding step.
